(19) United States
(12) Patent Application Publication
(10) Pub. No.: US 2026/0214216 A1
(43) Pub. Date: Jul. 23, 2026

(54) LOCAL ILLUMINATION COMPENSATION WITH EXTENDED MODELS

(71) Applicant: InterDigital CE Patent Holdings, SAS, Paris (FR)

(72) Inventors: Ya Chen, Rennes (FR); Philippe Bordes, Laille (FR); Karam Naser, Mouazé (FR); Edouard Francois, Bourg des Comptes (FR)

(73) Assignee: InterDigital CE Patent Holdings, SAS, Paris (FR)

(21) Appl. No.: 19/140,609

(22) PCT Filed: Dec. 21, 2023
(86) PCT No.: PCT/EP2023/087185

§ 371 Date: Jun. 18, 2025

(30) Foreign Application Priority Data
Dec. 22, 2022 (EP) 22307008.7

(51) Int. Cl. H04N 19/117; H04N 19/136; H04N 19/176; H04N 19/196; H04N 19/82

(52) U.S. Cl. CPC H04N 19/117; H04N 19/136; H04N 19/176; H04N 19/196; H04N 19/82

(57) ABSTRACT

Systems, devices, and methods are described herein for local illumination compensation (LIC) with extended models. An example device for video decoding may determine an LIC model for a block; obtain a set of LIC parameters based on the determined LIC model for the block; and decode the block based on the set of LIC parameters. An example device for video encoding may select a LIC model, from a plurality of LIC models, for block; obtain a set of LIC parameters based on the selected LIC model for the block; and encode the block based on the set of LIC parameters.

### CROSS-REFERENCE TO RELATED APPLICATIONS

This application claims the benefit of European Provisional Patent Application No. EP22307008.7, filed Dec. 22, 2022, the contents of which are hereby incorporated by reference herein.

### BACKGROUND

Video coding systems may be used to compress digital video signals, e.g., to reduce the storage and/or transmission bandwidth needed for such signals. Video coding systems may include, for example, block-based, wavelet-based, and/or object-based systems.

### SUMMARY

Systems, devices, and methods are described herein for local illumination compensation (LIC) with extended models. For example, filter-based models, gradient-based models, convolutional cross-component models (CCCM), and/or the like may be used for LIC.

An example device for video decoding (e.g., a video decoder) may determine to use a polynomial local illumination compensation (LIC) model for a block. The device may obtain a set of LIC parameters associated with the polynomial LIC model for the block. The device may decode the block based on the set of LIC parameters. The device may receive an LIC model indication in video data. The device may determine to use the polynomial LIC model for the block based on the LIC model indication.

An example video encoding device (e.g., a video encoder) may determine to use a polynomial LIC model for a block. The device may obtain a set of LIC parameters associated with the polynomial LIC model for the block. The device may encode the block based on the set of LIC parameters. The device may send an LIC model indication in video data, wherein the LIC model indication indicates to use the polynomial LIC model for the block.

The polynomial LIC model may be a filter-based model. The device (e.g., the video decoder or the video encoder) may identify a template sample of the block. The device may identify a first reference template sample, in a template of a reference block of the block, that corresponds to the template sample of the block. The device may identify a plurality of second reference template samples that neighbor the first reference template sample. The device may derive a set of filter coefficients based on minimizing a difference between the template sample of the block and a corresponding predicted template sample obtained based on the plurality of second reference template samples.

The polynomial LIC model may be a filter-based model. The device may, for a sample location in the block, identify a plurality of reference samples of a reference block associated with the block. The plurality of reference samples may include a center reference sample that corresponds to the sample location. The device may apply corresponding LIC parameters, from the set of LIC parameters, to the plurality of reference samples to generate a prediction sample of the block. An LIC parameter corresponding to the center reference sample may be applied to the center reference sample squared.

The polynomial LIC model may be a gradient-based model. The device may obtain the set of LIC parameters by deriving the set of LIC parameters based on a reference sample in a template of the block and a gradient of the reference sample. The device may obtain the set of LIC parameters by deriving the set of LIC parameters based on at least one of: a first reference block and a second reference block associated with the block; or a temporal gradient associated with the block.

The polynomial LIC model may be a gradient-based model. The device may apply the set of LIC parameters to a reference sample of a reference block and a gradient of the reference sample to obtain a refined prediction of the block. The device may reconstruct the block based on the refined prediction of the block.

In some examples, the device may determine to use a linear LIC model for a block. The device may obtain a set of LIC parameters associated with the linear LIC model for the block. The device may decode/encode the block based on the second set of LIC parameters.

The linear LIC model may be a filter-based model. The device may identify a template sample of the block. The device may identify a first reference template sample, in a template of a reference block of the block, that corresponds to the template sample of the block. The device may identify a plurality of second reference template samples that neighbor the first reference template sample. The device may derive a set of filter coefficients based on minimizing a difference between the template sample of the block and a corresponding predicted template sample obtained based on the plurality of second reference template samples.

The linear LIC model may be a filter-based model that comprises a set of filter coefficients. The device may, for a sample location in the block, identify a plurality of reference samples of a reference block associated with the block. The device may apply corresponding filter coefficients, from the set of filter coefficients, to the plurality of neighboring samples to generate a prediction sample of the block.

The linear LIC model may be a gradient-based model. The device may obtain a set of LIC parameters by deriving the set of LIC parameters based on a reference sample gradient of a reference block associated with the block.

An example device for video decoding may determine an LIC model for a block. The device may obtain an LIC parameter set based on the determined LIC model for the block. The device may decode the block based on the LIC parameter set. In an example, an LIC model indication may be received in video data, and the LIC model may be determined based on the LIC model indication. The device may refine a prediction of the block based on the obtained LIC parameter set, and may reconstruct the block based on the refined prediction of the block.

A device for video encoding may select an LIC model, from a plurality of LIC models, for a block. The device may obtain an LIC parameter set based on the selected LIC model for the block. The device may encode the block based on the LIC parameter set. The device may include an indication of the selected LIC model in the video data. The device may refine a prediction of the block based on the obtained LIC parameter set, and determine a residual of the block based on the refined prediction of the block.

Based on the determined (e.g., selected) LIC model for the block being a filter-based model, an LIC parameter may be derived based on a filter-based model. Based on the determined (e.g., selected) LIC model for the block being a gradient-based model, an LIC parameter may be derived based on a gradient-based model. Based on the determined (e.g., selected) LIC model for the block being a CCCM, an LIC parameter may be derived based on a polynomial model.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a diagram showing an example block-based video encoder.

FIG. 3 is a diagram showing an example video decoder.

FIG. 4 is a diagram showing an example of a system in which various aspects and examples may be implemented.

FIG. 5 illustrates an example LIC parameter estimation process.

FIG. 6 illustrates an example LIC parameter derivation process based on template samples derived on a sub-block basis.

FIG. 7 illustrates example locations of samples used in a cross-component linear model (CCLM) mode.

FIG. 8 illustrates an example of a linear relationship solved by a linear regression method.

FIG. 9A illustrates an example spatial part of a convolutional filter.

FIG. 9B illustrates an example reference area with six lines of chroma samples above and left of the block.

FIG. 10 illustrates example locations of samples that may be used to derive multiple linear regression (MLR) parameters for a filter-based model.

FIG. 11 illustrates four example Sobel-based gradient patterns from which a gradient G(x,y) may be calculated.

FIG. 12 illustrates example video game pictures where light propagates gradually across the picture.

FIG. 13 illustrates an example of decoding using LIC with a simple linear model.

FIG. 14 illustrates an example filter coefficients derivation process for LIC with a filter-based model.

FIG. 15 illustrates example filter shapes for LIC with a filter-based model.

FIG. 16 illustrates an example spatial part of a convolutional filter for LIC with a gradient-based model.

FIG. 17 illustrates an example illustrates 16 example Sobel-based gradient patterns from which a spatial gradient for LIC with a gradient-based model may be calculated.

FIG. 18 illustrates an example of decoding a block using LIC with extended models.

### DETAILED DESCRIPTION

A detailed description of illustrative embodiments will now be described with reference to the various Figures. Although this description provides a detailed example of possible implementations, it should be noted that the details are intended to be exemplary and in no way limit the scope of the application.

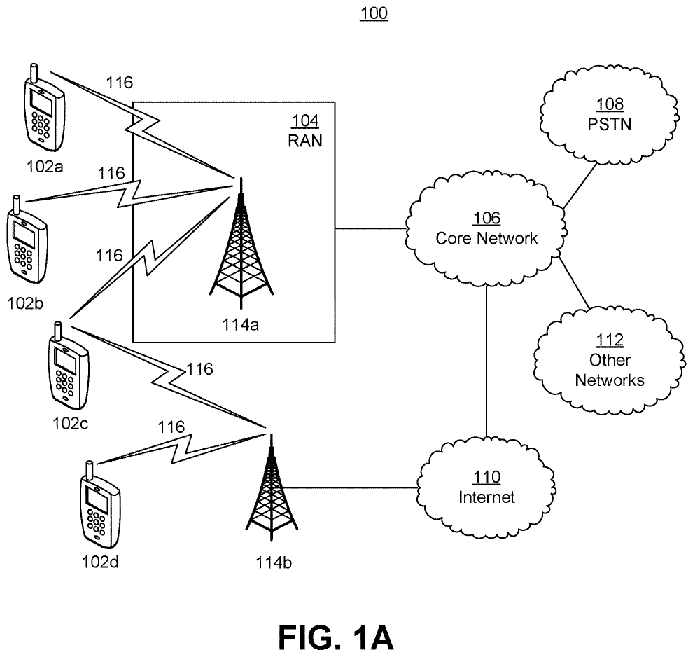

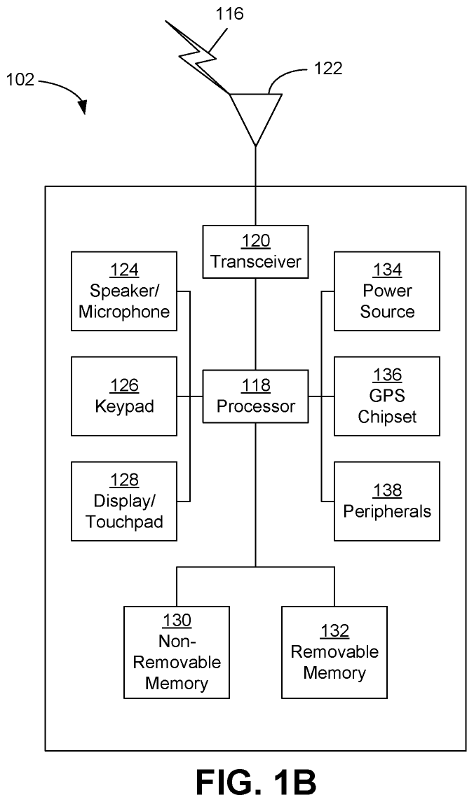

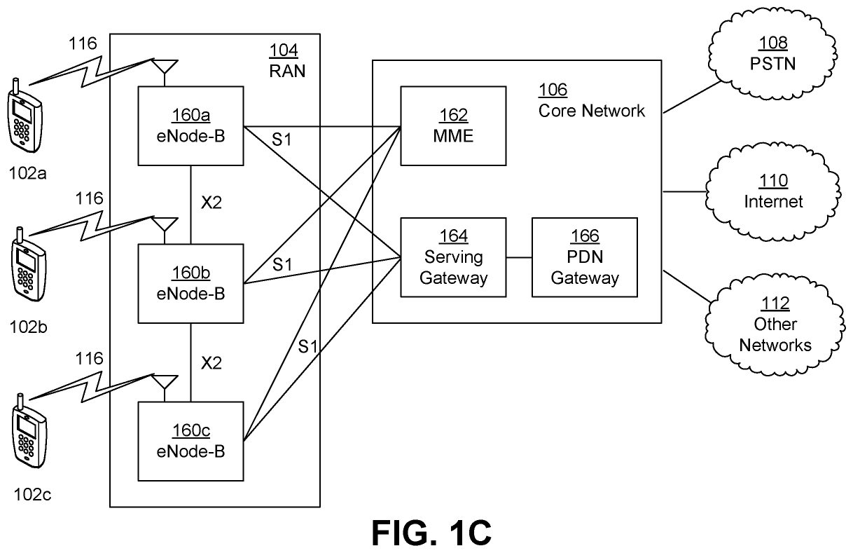

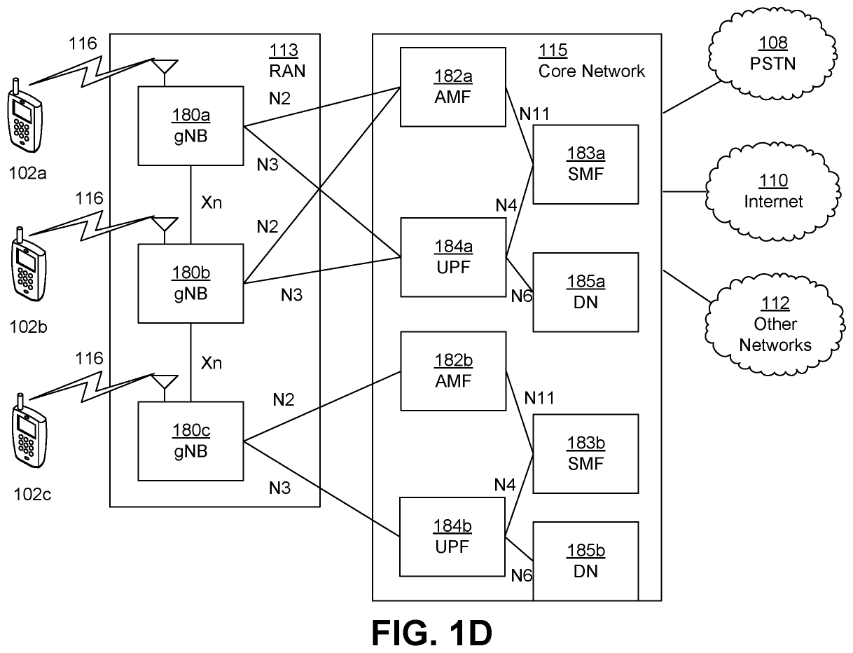

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN).

In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like.

The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11 ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

This application describes a variety of aspects, including tools, features, examples or embodiments, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects may be combined and interchanged to provide further aspects. Moreover, the aspects may be combined and interchanged with aspects described in earlier filings as well.

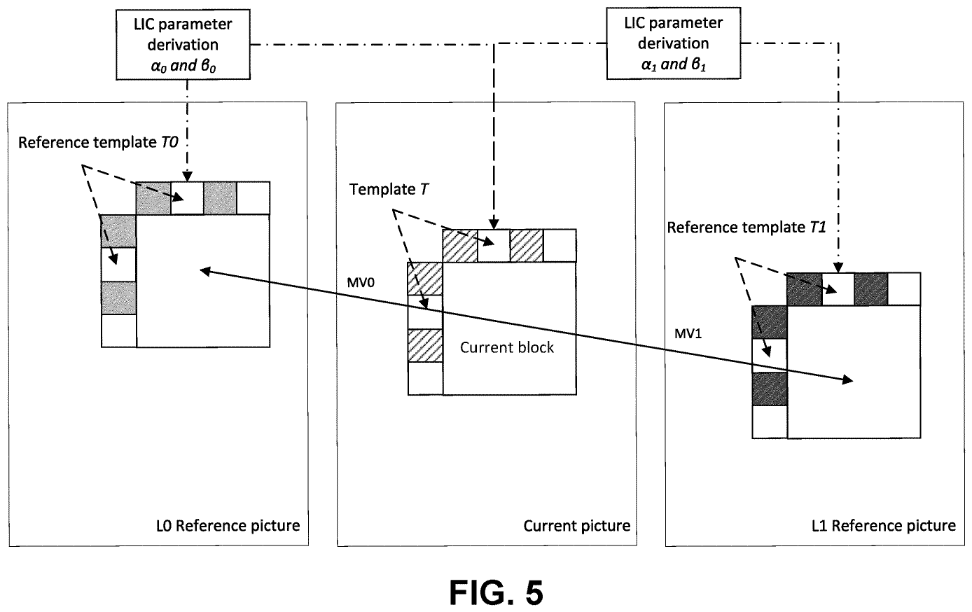

The aspects described and contemplated in this application may be implemented in many different forms. FIGS. 5-18 described herein may provide some embodiments, but other embodiments are contemplated. The discussion of FIGS. 5-18 does not limit the breadth of the implementations. At least one of the aspects generally relates to video encoding and decoding, and at least one other aspect generally relates to transmitting a bitstream generated or encoded. These and other aspects may be implemented as a method, an apparatus, a computer readable storage medium having stored thereon instructions for encoding or decoding video data according to any of the methods described, and/or a computer readable storage medium having stored thereon a bitstream generated according to any of the methods described.

In the present application, the terms “reconstructed” and “decoded” may be used interchangeably, the terms “pixel” and “sample” may be used interchangeably, the terms “image,” “picture” and “frame” may be used interchangeably.

The terms HDR (high dynamic range) and SDR (standard dynamic range) may be used in this disclosure. Those terms often convey specific values of dynamic range to those of ordinary skill in the art. However, additional embodiments are also intended in which a reference to HDR is understood to mean “higher dynamic range” and a reference to SDR is understood to mean “lower dynamic range.” Such additional embodiments are not constrained by any specific values of dynamic range that might often be associated with the terms “high dynamic range” and “standard dynamic range.”

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., such as, for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

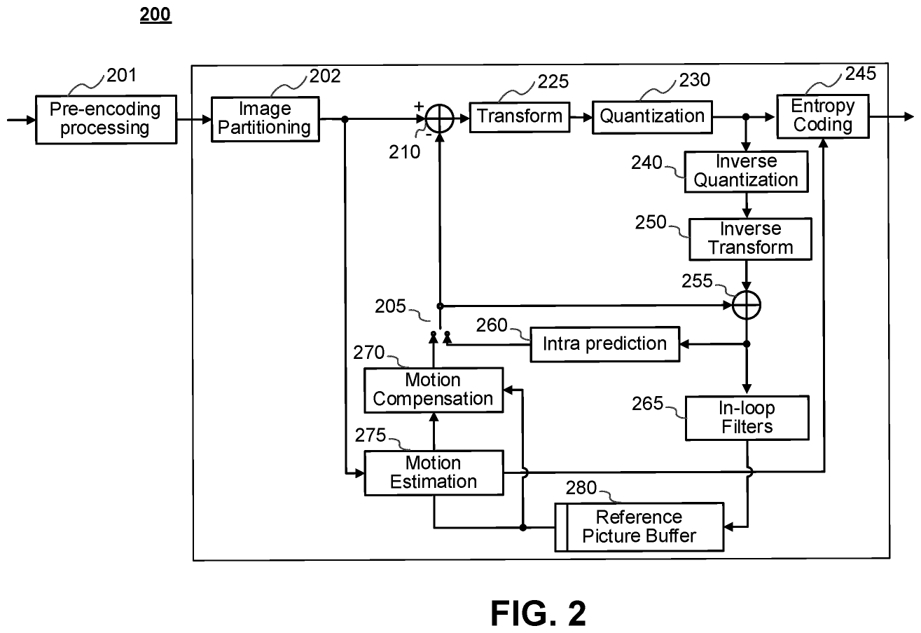

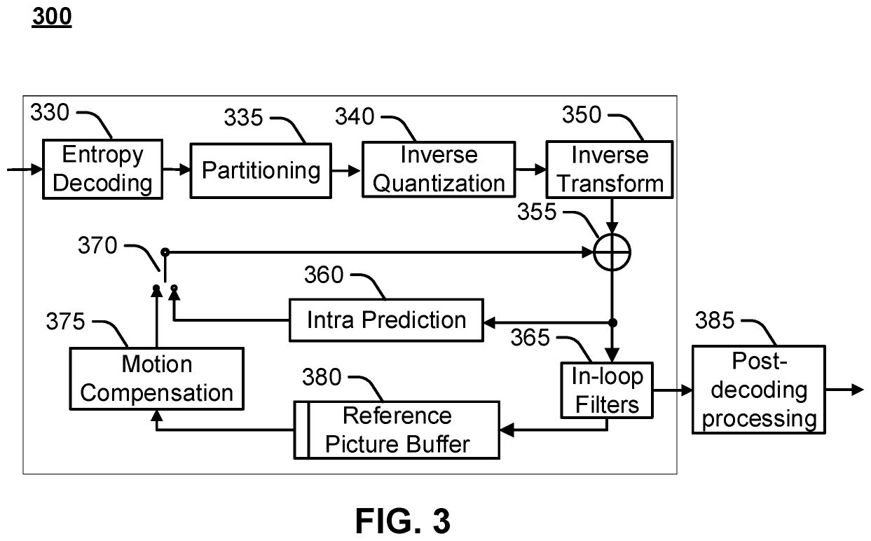

Various methods and other aspects described in this application may be used to modify modules, for example, intra prediction and entropy coding and/or decoding modules (260, 360, 245, 330), of a video encoder 200 and decoder 300 as shown in FIG. 2 and FIG. 3, respectively. Moreover, the subject matter disclosed herein presents aspects that are not limited to VVC or HEVC, and may be applied, for example, to any type, format or version of video coding, whether described in a standard or a recommendation, whether pre-existing or future-developed, and extensions of any such standards and recommendations (e.g., including VVC and HEVC). Unless indicated otherwise, or technically precluded, the aspects described in this application may be used individually or in combination.

Various numeric values are used in examples described the present application, such as coefficients, block sizes, etc. These and other specific values are for purposes of describing examples and the aspects described are not limited to these specific values.

FIG. 2 is a diagram showing an example video encoder (e.g., an example block-based hybrid video encoder) 200. Variations of example encoder 200 are contemplated, but the encoder 200 is described below for purposes of clarity without describing all expected variations.

Before being encoded, the video sequence may go through pre-encoding processing (201), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata may be associated with the pre-processing, and attached to the bitstream.

In the encoder 200, a picture is encoded by the encoder elements as described below. The picture to be encoded is partitioned (202) and processed in units of, for example, coding units (CUs). Each unit is encoded using, for example, either an intra or inter mode. When a unit is encoded in an intra mode, it performs intra prediction (260). In an inter mode, motion estimation (275) and compensation (270) are performed. The encoder decides (205) which one of the intra mode or inter mode to use for encoding the unit, and indicates the intra/inter decision by, for example, a prediction mode flag. Prediction residuals are calculated, for example, by subtracting (210) the predicted block from the original image block.

The prediction residuals are then transformed (225) and quantized (230). The quantized transform coefficients, as well as motion vectors and other syntax elements, are entropy coded (245) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (240) and inverse transformed (250) to decode prediction residuals. Combining (255) the decoded prediction residuals and the predicted block, an image block is reconstructed. In-loop filters (265) are applied to the reconstructed picture to perform, for example, deblocking/SAO (Sample Adaptive Offset) filtering to reduce encoding artifacts. The filtered image is stored at a reference picture buffer (280).

FIG. 3 is a diagram showing an example of a video decoder 300. In example decoder 300, a bitstream is decoded by the decoder elements as described below. Video decoder 300 generally performs a decoding pass reciprocal to the encoding pass as described in FIG. 2. The encoder 200 also generally performs video decoding as part of encoding video data.

In particular, the input of the decoder includes a video bitstream, which may be generated by video encoder 200. The bitstream is first entropy decoded (330) to obtain transform coefficients, motion vectors, and other coded information. The picture partition information indicates how the picture is partitioned. The decoder may therefore divide (335) the picture according to the decoded picture partitioning information. The transform coefficients are de-quantized (340) and inverse transformed (350) to decode the prediction residuals. Combining (355) the decoded prediction residuals and the predicted block, an image block is reconstructed. The predicted block may be obtained (370) from intra prediction (360) or motion-compensated prediction (i.e., inter prediction) (375). In-loop filters (365) are applied to the reconstructed image. The filtered image is stored at a reference picture buffer (380). For a given picture, the contents of the reference picture buffer 380 on the decoder 300 side may be identical to the contents of the reference picture buffer 280 on the encoder 200 side for the same picture.

The decoded picture can further go through post-decoding processing (385), for example, an inverse color transform (e.g., conversion from YCbCr 4:2:0 to RGB 4:4:4) or an inverse remapping performing the inverse of the remapping process performed in the pre-encoding processing (201). The post-decoding processing can use metadata derived in the pre-encoding processing and signaled in the bitstream.

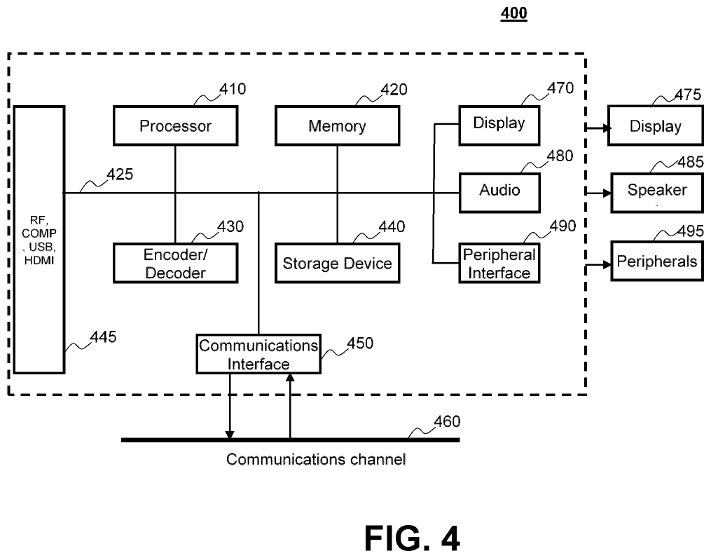

FIG. 4 is a diagram showing an example of a system in which various aspects and embodiments described herein may be implemented. System 400 may be embodied as a device including the various components described below and is configured to perform one or more of the aspects described in this document. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 400, singly or in combination, may be embodied in a single integrated circuit (IC), multiple ICs, and/or discrete components. For example, in at least one example, the processing and encoder/decoder elements of system 400 are distributed across multiple ICs and/or discrete components.

In various embodiments, the system 400 is communicatively coupled to one or more other systems, or other electronic devices, via, for example, a communications bus or through dedicated input and/or output ports. In various embodiments, the system 400 is configured to implement one or more of the aspects described in this document.

The system 400 includes at least one processor 410 configured to execute instructions loaded therein for implementing, for example, the various aspects described in this document. Processor 410 can include embedded memory, input output interface, and various other circuitries as known in the art. The system 400 includes at least one memory 420 (e.g., a volatile memory device, and/or a non-volatile memory device). System 400 includes a storage device 440, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 440 can include an internal storage device, an attached storage device (including detachable and non-detachable storage devices), and/or a network accessible storage device, as non-limiting examples.

System 400 includes an encoder/decoder module 430 configured, for example, to process data to provide an encoded video or decoded video, and the encoder/decoder module 430 can include its own processor and memory. The encoder/decoder module 430 represents module(s) that may be included in a device to perform the encoding and/or decoding functions. As is known, a device can include one or both of the encoding and decoding modules. Additionally, encoder/decoder module 430 may be implemented as a separate element of system 400 or may be incorporated within processor 410 as a combination of hardware and software as known to those skilled in the art.

Program code to be loaded onto processor 410 or encoder/decoder 430 to perform the various aspects described in this document may be stored in storage device 440 and subsequently loaded onto memory 420 for execution by processor 410. In accordance with various embodiments, one or more of processor 410, memory 420, storage device 440, and encoder/decoder module 430 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some embodiments, memory inside of the processor 410 and/or the encoder/decoder module 430 is used to store instructions and to provide working memory for processing that is needed during encoding or decoding. In other embodiments, however, a memory external to the processing device (for example, the processing device may be either the processor 410 or the encoder/decoder module 430) is used for one or more of these functions. The external memory may be the memory 420 and/or the storage device 440, for example, a dynamic volatile memory and/or a non-volatile flash memory. In several embodiments, an external non-volatile flash memory is used to store the operating system of, for example, a television. In at least one embodiment, a fast external dynamic volatile memory such as a RAM is used as working memory for video coding and decoding operations, such as, for example, MPEG-2 (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or WC (Versatile Video Coding, a new standard being developed by JVET, the Joint Video Experts Team).

The input to the elements of system 400 may be provided through various input devices as indicated in block 445. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 4, include composite video.

In various embodiments, the input devices of block 445 have associated respective input processing elements as known in the art. For example, the RF portion may be associated with elements suitable for (i) selecting a desired frequency (also referred to as selecting a signal, or band-limiting a signal to a band of frequencies), (ii) down-converting the selected signal, (iii) band-limiting again to a narrower band of frequencies to select (for example) a signal frequency band which may be referred to as a channel in certain embodiments, (iv) demodulating the down-converted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, down-converting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, down-converting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF portion includes an antenna.

Additionally, the USB and/or HDMI terminals can include respective interface processors for connecting system 400 to other electronic devices across USB and/or HDMI connections. It is to be understood that various aspects of input processing, for example, Reed-Solomon error correction, may be implemented, for example, within a separate input processing IC or within processor 410 as necessary. Similarly, aspects of USB or HDMI interface processing may be implemented within separate interface ICs or within processor 410 as necessary. The demodulated, error corrected, and demultiplexed stream is provided to various processing elements, including, for example, processor 410, and encoder/decoder 430 operating in combination with the memory and storage elements to process the data stream as necessary for presentation on an output device.

Various elements of system 400 may be provided within an integrated housing, Within the integrated housing, the various elements may be interconnected and transmit data therebetween using suitable connection arrangement 425, for example, an internal bus as known in the art, including the Inter-IC (I2C) bus, wiring, and printed circuit boards.

The system 400 includes communication interface 450 that enables communication with other devices via communication channel 460. The communication interface 450 can include, but is not limited to, a transceiver configured to transmit and to receive data over communication channel 460. The communication interface 450 can include, but is not limited to, a modem or network card and the communication channel 460 may be implemented, for example, within a wired and/or a wireless medium.

Data is streamed, or otherwise provided, to the system 400, in various embodiments, using a wireless network such as a Wi-Fi network, for example IEEE 802.11 (IEEE refers to the Institute of Electrical and Electronics Engineers). The Wi-Fi signal of these examples is received over the communications channel 460 and the communications interface 450 which are adapted for Wi-Fi communications. The communications channel 460 of these embodiments is typically connected to an access point or router that provides access to external networks including the Internet for allowing streaming applications and other over-the-top communications. Other embodiments provide streamed data to the system 400 using a set-top box that delivers the data over the HDMI connection of the input block 445. Still other embodiments provide streamed data to the system 400 using the RF connection of the input block 445. As indicated above, various embodiments provide data in a non-streaming manner. Additionally, various embodiments use wireless networks other than Wi-Fi, for example a cellular network or a Bluetooth network.

The system 400 can provide an output signal to various output devices, including a display 475, speakers 485, and other peripheral devices 495. The display 475 of various embodiments includes one or more of, for example, a touchscreen display, an organic light-emitting diode (OLED) display, a curved display, and/or a foldable display. The display 475 may be for a television, a tablet, a laptop, a cell phone (mobile phone), or other device. The display 475 can also be integrated with other components (for example, as in a smart phone), or separate (for example, an external monitor for a laptop). The other peripheral devices 495 include, in various examples of embodiments, one or more of a stand-alone digital video disc (or digital versatile disc) (DVR, for both terms), a disk player, a stereo system, and/or a lighting system. Various embodiments use one or more peripheral devices 495 that provide a function based on the output of the system 400. For example, a disk player performs the function of playing the output of the system 400.

In various embodiments, control signals are communicated between the system 400 and the display 475, speakers 485, or other peripheral devices 495 using signaling such as AV.Link, Consumer Electronics Control (CEC), or other communications protocols that enable device-to-device control with or without user intervention. The output devices may be communicatively coupled to system 400 via dedicated connections through respective interfaces 470, 480, and 490. Alternatively, the output devices may be connected to system 400 using the communications channel 460 via the communications interface 450. The display 475 and speakers 485 may be integrated in a single unit with the other components of system 400 in an electronic device such as, for example, a television. In various embodiments, the display interface 470 includes a display driver, such as, for example, a timing controller (T Con) chip.

The display 475 and speakers 485 can alternatively be separate from one or more of the other components, for example, if the RF portion of input 445 is part of a separate set-top box. In various embodiments in which the display 475 and speakers 485 are external components, the output signal may be provided via dedicated output connections, including, for example, HDMI ports, USB ports, or COMP outputs.

The embodiments may be carried out by computer software implemented by the processor 410 or by hardware, or by a combination of hardware and software. As a non-limiting example, the embodiments may be implemented by one or more integrated circuits. The memory 420 may be of any type appropriate to the technical environment and may be implemented using any appropriate data storage technology, such as optical memory devices, magnetic memory devices, semiconductor-based memory devices, fixed memory, and removable memory, as non-limiting examples. The processor 410 may be of any type appropriate to the technical environment, and can encompass one or more of microprocessors, general purpose computers, special purpose computers, and processors based on a multi-core architecture, as non-limiting examples.

Various implementations involve decoding. “Decoding”, as used in this application, can encompass all or part of the processes performed, for example, on a received encoded sequence in order to produce a final output suitable for display. In various embodiments, such processes include one or more of the processes typically performed by a decoder, for example, entropy decoding, inverse quantization, inverse transformation, and differential decoding. In various embodiments, such processes also, or alternatively, include processes performed by a decoder of various implementations described in this application, for example, determining a local illumination compensation (LIC) model for a block; obtaining an LIC parameter set based on the determined LIC model for the block; and decoding the block based on the LIC parameter set, etc. A block may be, for example, a coding block.

As further embodiments, in one example “decoding” refers only to entropy decoding, in another embodiment “decoding” refers only to differential decoding, and in another embodiment “decoding” refers to a combination of entropy decoding and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence in order to produce an encoded bitstream. In various embodiments, such processes include one or more of the processes typically performed by an encoder, for example, partitioning, differential encoding, transformation, quantization, and entropy encoding. In various embodiments, such processes also, or alternatively, include processes performed by an encoder of various implementations described in this application, for example, selecting an LIC model, from a plurality of LIC models, for a block; obtaining an LIC parameter set based on the selected LIC model for the block; and encoding the block based on the LIC parameter set, etc. A block may be, for example, a coding block.

As further examples, in one embodiment “encoding” refers only to entropy encoding, in another embodiment “encoding” refers only to differential encoding, and in another embodiment “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

Note that syntax elements as used herein, for example, LIC_model, filter_idx, grad_pattern_idx, etc., are descriptive terms. As such, they do not preclude the use of other syntax element names.

When a figure is presented as a flow diagram, it should be understood that it also provides a block diagram of a corresponding apparatus. Similarly, when a figure is presented as a block diagram, it should be understood that it also provides a flow diagram of a corresponding method/process.

Various embodiments refer to rate distortion optimization. In particular, during the encoding process, the balance or trade-off between the rate and distortion is usually considered, often given the constraints of computational complexity. The rate distortion optimization is usually formulated as minimizing a rate distortion function, which is a weighted sum of the rate and of the distortion. There are different approaches to solve the rate distortion optimization problem. For example, the approaches may be based on an extensive testing of all encoding options, including all considered modes or coding parameters values, with a complete evaluation of their coding cost and related distortion of the reconstructed signal after coding and decoding. Faster approaches may also be used, to save encoding complexity, in particular with computation of an approximated distortion based on the prediction or the prediction residual signal, not the reconstructed one. Mix of these two approaches can also be used, such as by using an approximated distortion for only some of the possible encoding options, and a complete distortion for other encoding options. Other approaches only evaluate a subset of the possible encoding options. More generally, many approaches employ any of a variety of techniques to perform the optimization, but the optimization is not necessarily a complete evaluation of both the coding cost and related distortion.

The implementations and aspects described herein may be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus may be implemented in, for example, appropriate hardware, software, and firmware. The methods may be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment,” “an embodiment,” “an example,” “one implementation” or “an implementation,” as well as other variations thereof, means that a particular feature, structure, characteristic, and so forth described in connection with the embodiment is included in at least one embodiment. Thus, the appearances of the phrase “in one embodiment,” “in an embodiment,” “in an example,” “in one implementation,” or “in an implementation”, as well any other variations, appearing in various places throughout this application are not necessarily all referring to the same embodiment or example.

Additionally, this application may refer to “determining” various pieces of information. Determining the information can include one or more of, for example, estimating the information, calculating the information, predicting the information, or retrieving the information from memory. Obtaining may include receiving, retrieving, constructing, generating, and/or determining.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling may be used without transmitting (implicit signaling) to simply allow the decoder to know and select the particular parameter. By avoiding transmission of any actual functions, a bit savings is realized in various embodiments. It is to be appreciated that signaling may be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations may produce a variety of signals formatted to carry information that may be, for example, stored or transmitted. The information can include, for example, instructions for performing a method, or data produced by one of the described implementations. For example, a signal may be formatted to carry the bitstream of a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

Many embodiments are described herein. Features of embodiments may be provided alone or in any combination, across various claim categories and types. Further, embodiments may include one or more of the features, devices, or aspects described herein, alone or in any combination, across various claim categories and types. For example, features described herein can be implemented in a bitstream or signal that includes information generated as described herein. The information can allow a decoder to decode a bitstream, the encoder, bitstream, and/or decoder according to any of the embodiments described. For example, features described herein can be implemented by creating and/or transmitting and/or receiving and/or decoding a bitstream or signal. For example, features described herein can be implemented a method, process, apparatus, medium storing instructions, medium storing data, or signal. For example, features described herein can be implemented by a TV, set-top box, cell phone, tablet, or other electronic device that performs decoding. The TV, set-top box, cell phone, tablet, or other electronic device can display (e.g., using a monitor, screen, or other type of display) a resulting image (e.g., an image from residual reconstruction of the video bitstream). The TV, set-top box, cell phone, tablet, or other electronic device can receive a signal including an encoded image and perform decoding.

Feature(s) associated with local illumination compensation (LIC) are provided herein.

In some inter prediction processes, LIC is a coding tool that may be used to address the issue of local illumination changes between temporal neighboring pictures. A block may be decoded based on a set of LIC parameters. For example, LIC may be based on a linear model where LIC parameters (e.g., a scaling factor α and an offset β) are applied to reference samples to obtain prediction samples of a current block. LIC may be mathematically modelled by the following equation:

$$P ( x , y ) = α * {P}_{r} ( x + {v}_{x} , y + {v}_{y} ) + β$$

where P(x,y) represents the prediction signal of the current block a the coordinate (x,y); Pᵣ(x+vₓ,y+v_{y}) represents the prediction signal of the reference block obtained based on the motion vector (vₓ,v_{y}); and α and β represent the corresponding scaling factor and offset, respectively, applied to the reference block.

A device may obtain a set of LIC parameters associated with an LIC model (e.g., a linear or polynomial LIC model) for a block. FIG. 5 illustrates an example LIC parameter estimation process. In FIG. 5, when LIC is applied to a block, a Least-Mean-Square-Error (LMSE) method may be used to derive the values of the LIC parameters (e.g., α and β) by minimizing the difference between the reconstructed neighboring samples (e.g., in a left column and an above row of the current block, for example, the template T in FIG. 5) and corresponding neighboring samples in the current block's reference blocks (e.g., either T₀ or T₁ in FIG. 5):

$$α = \frac{\begin{matrix}N * {\sum }_{i = 1}^{N} T ( {x}_{i} , {y}_{i} ) * {T}_{0 / 1} ( {x}_{i} + {v}_{x}^{0 / 1} , {y}_{i} + {v}_{y}^{0 / 1} ) - {\sum }_{i = 1}^{N} T ( {x}_{i} , {y}_{i} ) * \\ {\sum }_{i = 1}^{N} {T}_{0 / 1} ( {x}_{i} + {v}_{x}^{0 / 1} , {y}_{i} + {v}_{y}^{0 / 1} )\end{matrix}}{\begin{matrix}N * {\sum }_{i = 1}^{N} {T}_{0 / 1} ( {x}_{i} + {v}_{x}^{0 / 1} , {y}_{i} + {v}_{y}^{0 / 1} ) * {T}_{0 / 1} ( {x}_{i} + {v}_{x}^{0 / 1} , {y}_{i} + {v}_{y}^{0 / 1} ) - \\ {( {\sum }_{i = 1}^{N} {T}_{0 / 1} ( {x}_{i} + {v}_{x}^{0 / 1} , {y}_{i} + {v}_{y}^{0 / 1} ) )}^{2}\end{matrix}}$$

$$β = \frac{{\sum }_{i = 1}^{N} T ( {x}_{i} , {y}_{i} ) - α * {\sum }_{i = 1}^{N} {T}_{0 / 1} ( {x}_{i} + {v}_{x}^{0 / 1} , {y}_{i} + {v}_{y}^{0 / 1} )}{N}$$

where N represents the number of template samples that are used for deriving the LIC parameters; T(xᵢ,yᵢ) represents the template sample of the current block at the coordinate (xᵢ,yᵢ); and

$${T}_{0 / 1} ( {x}_{i} + {v}_{x}^{0 / 1} , {y}_{i} + {v}_{y}^{0 / 1} )$$

represents the corresponding reference sample of the template sample based on the motion vector

$$( {v}_{x}^{0 / 1} , {v}_{y}^{0 / 1} )$$

(either L0 or L1) of the current block. The template samples and the reference template samples may be subsampled (e.g., 2:1 subsampling, for example, to reduce computational complexity) to derive the LIC parameters for block size is larger than 8×8 (e.g., only the shaded samples in FIG. 5 are used to derive α and β).

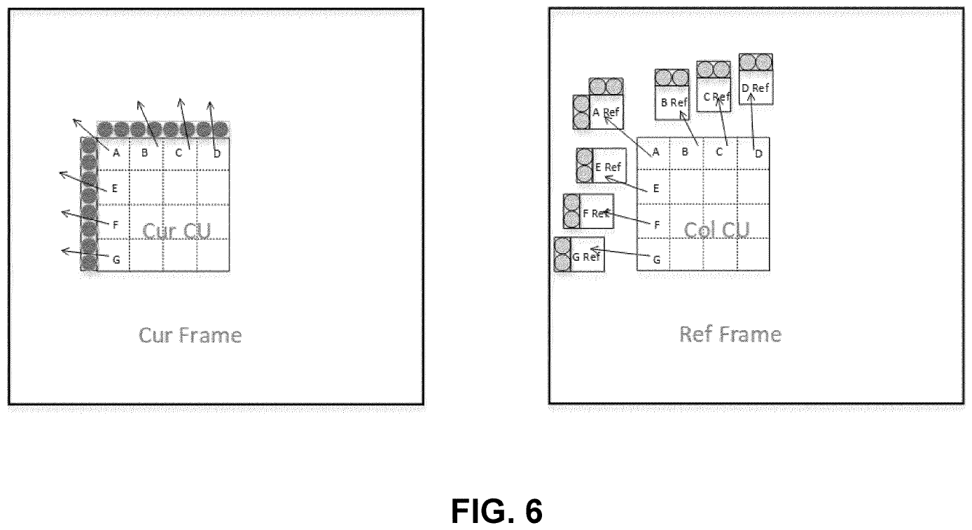

LIC may be applied to a sub-block mode (e.g., affine mode). In a sub-block mode, LIC parameters may be derived based on template samples derived on a sub-block basis, as illustrated in FIG. 6. The reference samples in the top template may be fetched by sub-block MVs (e.g., each sub-block MVs) in the top row and the reference samples in the left template may be fetched by sub-block MVs (e.g., each sub-block MVs) in left column. The derivation of LIC parameters may be kept unchanged.

The LIC parameters α and β may be derived based on current block template T and reference block template T_{0/1} at the encoder and decoder.

If an inter block is predicted with merge mode, an LIC flag may be included as a part of motion information (e.g., in addition to Motion Vector Predictors (MVPs) and reference indices). If a merge candidate list is constructed, the LIC flag may be inherited from the neighbor blocks for merge candidates. In some examples (e.g., when an inter block is predicted with non-merge modes), the LIC flag may be context-coded with a single context. If the LIC tool is not applicable, the LIC flag may not be signaled.

LIC may be applied to both luma and chroma components with one or more of the following configurations: disable LIC for combined inter/intra prediction (CIIP) and intra block copy (IBC) blocks; disable LIC for blocks with less than 32 luma samples; no temporal inheritance of LIC flag; no pruning based on LIC flag in merging candidate list generation; LIC is not applied to bi-prediction; and/or samples of the reference block template are generated by using motion compensation (MC) with the block MV without rounding it to integer-pel precision.

Feature(s) associated with cross-component linear model (CCLM) are provided herein. Feature(s) associated with enhanced CCLM are provided herein.

CCLM chroma intra prediction may be used to exploit the relationship between the luma and chroma components. The chroma samples may be predicted based on the reconstructed luma samples of the same coding unit (CU) by using a linear model as follows:

$$P r e {d}_{C} ( x , y ) = α * {Rec}_{L}^{′} ( x , y ) + β$$

where Pred_{C}(x,y) represents the predicted chroma samples in a CU at the coordinate (x,y); and Rec_{L}′(x,y) represents the down-sampled reconstructed luma samples of the CU (e.g., the same CU). The parameters α and β may be derived from the reconstructed samples around the current block.

CCLM may use the LMSE approach (e.g., similar to LIC) between neighboring reconstructed down-sampled luma samples and causal chroma samples to derive the model parameters α and β:

$$α = \frac{\begin{matrix}I * {\sum }_{i = 1}^{I} {Rec}_{C} ( {x}_{i} , {y}_{i} ) * {Rec}_{L}^{′} ( {x}_{i} , {y}_{i} ) - \\ {\sum }_{i = 1}^{I} {Rec}_{C} ( {x}_{i} , {y}_{i} ) * {\sum }_{i = 1}^{I} {Rec}_{L}^{′} ( {x}_{i} , {y}_{i} )\end{matrix}}{I * {\sum }_{i = 1}^{I} {Rec}_{L}^{′} ( {x}_{i} , {y}_{i} ) * {Rec}_{L}^{′} ( {x}_{i} , {y}_{i} ) - {( {\sum }_{i = 1}^{I} {Rec}_{L}^{′} ( {x}_{i} , {y}_{i} ) )}^{2}}$$

$$β = \frac{{\sum }_{i = 1}^{I} {Rec}_{C} ( {x}_{i} , {y}_{i} ) - α * {\sum }_{i = 1}^{I} {Rec}_{L}^{′} ( {x}_{i} , {y}_{i} )}{I}$$

where I represents the total samples number of neighboring data; and Rec_{C}(xᵢ,yᵢ) represents the reconstructed chroma samples around the target CU.

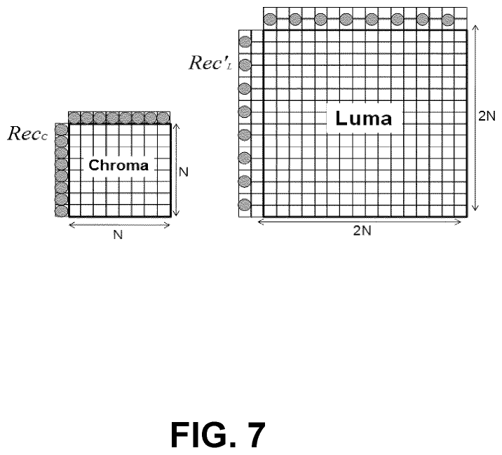

As illustrated in FIG. 7, the left and above causal samples (e.g., marked as gray circles) may be involved in the calculation to keep the number of total samples I as a power of 2. For a target N×N chroma block, if left and above causal samples are available (e.g., are both available), the total number of involved samples is 2N. For a target N×N chroma block, if left causal samples or above causal samples (e.g., only left or above causal samples) are available, the total number of involved samples is N.

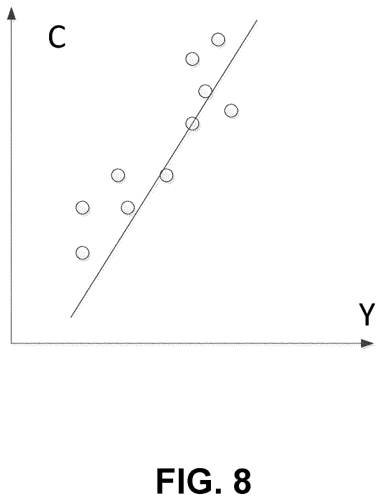

FIG. 8 illustrates an example of the linear relationship solved by a linear regression method. A point on the graph of FIG. 8 may correspond to a pair of luma and chroma samples (Y, C).

Feature(s) associated with convolutional cross-component model (CCCM) are provided herein.

The CCCM may predict chroma samples from reconstructed luma samples (e.g., in a similar manner as CCLM). The reconstructed luma samples may be down-sampled to match the lower resolution chroma grid when chroma sub-sampling is used (e.g., as is done in CCLM).

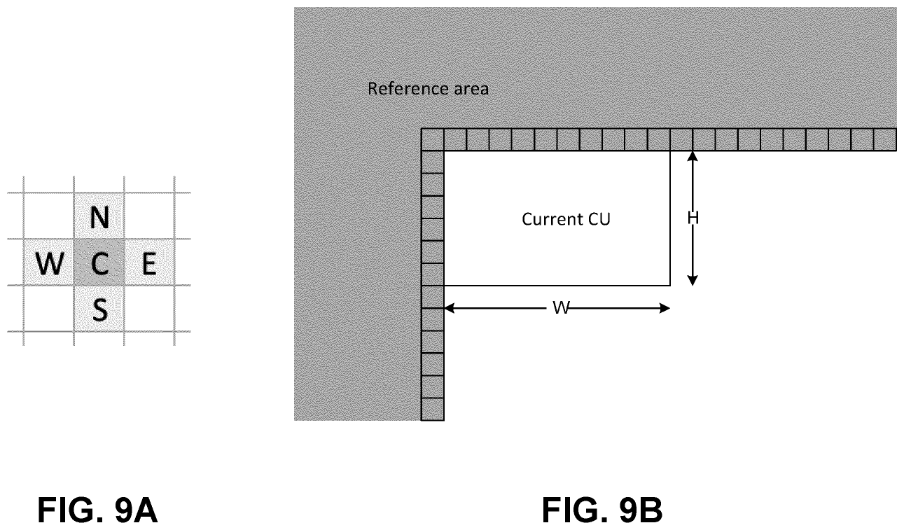

A convolutional 7-tap filter may include a 5-tap plus sign shape spatial component, a nonlinear term, and a bias term. The input to the spatial 5-tap component of the filter may include a center (C) luma sample (e.g., which may be collocated with the chroma sample to be predicted) and its above/north (N), below/south (S), left/west (W) and right/east (E) neighbors as illustrated in FIG. 9A. An output of the filter may be calculated as a convolution between the filter coefficients cᵢ and the input values, and clipped to a range of chroma samples (e.g., valid chroma samples):

$$P r e {d}_{c} = {c}_{0} * C + {c}_{1} * N + {c}_{2} * S + {c}_{3} * E + {c}_{4} * W + {c}_{5} * P + {c}_{6} * B$$

where the nonlinear term P represents a power of two of the center luma sample C (e.g., and scaled to the sample value range of the content), and the bias term B represents a scalar offset between the input and output (e.g., similar to the offset term used in CCLM). The bias term B may be set to middle chroma value. For example, for 10-bit content the nonlinear term P and the bias term B may be calculated as:

$$P = ( C * C + 512 ) >> 10 ,$$

$$B = 51 \; 2 .$$

The filter coefficients cᵢ may be calculated by minimizing MSE between predicted and reconstructed chroma samples in the reference area. FIG. 9B illustrates an example reference area, which includes six lines of chroma samples above and left of the block. The reference area may extend one block width to the right and one block height below the block boundaries.

The MSE minimization may be performed by calculating an autocorrelation matrix for the luma input and a cross-correlation vector between the luma input and the chroma output. The autocorrelation matrix may be LDL decomposed and the final filter coefficients are calculated using back-substitution. The process may follow (e.g., roughly follow) the calculation of adaptive loop filter (ALF) coefficients. LDL decomposition may be used (e.g., instead of Cholesky decomposition) to avoid using square root operations. For example, integer arithmetic (e.g., only integer arithmetic) may be used in the MSE minimization.

The encoder may perform a rate distortion (RD) check in the chroma prediction mode loop. CCCM may be considered a sub-mode of CCLM (e.g., with respect to signaling). Usage of the CCCM mode may be signaled with a context-adaptive binary arithmetic coding (CABAC)-coded PU-level flag.

Feature(s) associated with a filter-based linear model (FLM) are provided herein.

FLM may be used to improve CCLM. The FLM may extend the simple linear regression (SLR) in the CCLM to multiple linear regression (MLR), which may be expressed as:

$$P r e {d}_{C} = {\sum }_{i = 0}^{N - 1} {α}_{i} * {Rec}_{L i}^{′} + β$$

where Pred_{C} represents the to-be-predicted chroma sample; Rec_{L′i} represents the i-th reconstructed luma sample surround the chroma sample; αᵢ represents the i-th coefficient; β represents the offset; and N represents the number of the involved luma samples.

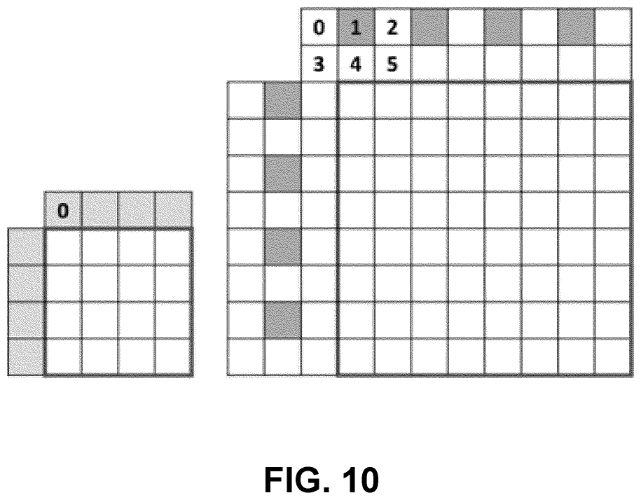

As illustrated in FIG. 10, a number of neighboring luma and chroma template samples (e.g., the same number of neighboring luma/chroma template samples as CCLM, for example, top 2 rows/left 3 columns luma samples and top 1 row/left 1 column chroma samples) may be used to derive the MLR parameters (e.g., through the Cholesky decomposition). In some FLM designs, multiple filter shapes may be supported (e.g., with the number of filter shapes N ranging from, for example, 2 to 6). The selection of filter shape may be performed (e.g., switched) at the CU level.

Feature(s) associated with a gradient linear model (GLM) are provided herein.

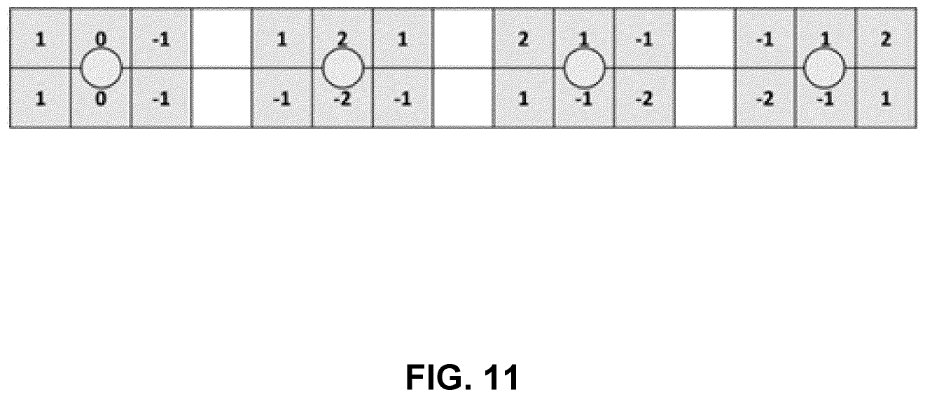

GLM may use luma sample gradients to derive the linear model (e.g., instead of using down-sampled luma values, as is done in CCLM). For example, a gradient G (e.g., rather than a low pass filtered luma sample) may be used in the CCLM process:

$$p r e {d}_{c} ( x , y ) = α * G ( x , y ) + β$$

where pred_{C}(x,y) represents the predicted value of a chroma sample; and G(x,y) represents the gradient of the corresponding reconstructed luma samples. The linear model parameters α and β may be derived by adjacent reconstructed samples (e.g., based on the LMSE method as is done in CCLM). FIG. 11 illustrates that the gradient G(x,y) may be calculated by a gradient pattern (e.g., one of four Sobel-based gradient patterns).

For signaling, if the CCLM mode is enabled to the current CU, one or more (e.g., two) flags may be signaled (e.g., separately) for the Cb and Cr components (e.g., one flag for each of the Cb and Cr components). The two flags may indicate whether GLM is enabled for the Cb and/or Cr component. If the GLM is enabled for one component, one syntax element may be signaled (e.g., further signaled) to select a gradient pattern (e.g., one of four gradient patterns) for the gradient calculation, as illustrated in FIG. 11.

Feature(s) associated with GLM with a luma value are provided herein.

A GLM mode in which both the gradient G(x,y) of luma samples and the reconstructed value

$${Rec}_{L}^{′} ( x , y )$$

of the down-sampled luma sample may be used to predict the chroma sample with different parameters:

$$p r e {d}_{C} ( x , y ) = {α}_{0} * G ( x , y ) + {α}_{1} * {Rec}_{L}^{′} ( x , y ) + {α}_{2} * midValue$$

where the model parameters α₀, α₁, and α₂ may be derived from six rows and columns adjacent samples (e.g., based on the LDL decomposition method as is done in the CCCM mode).

For signaling, the GLM mode (e.g., in which both the gradient G(x,y) of luma samples and the reconstructed value

$${Rec}_{L}^{′} ( x , y )$$

of the down-sampled luma sample may be used to predict the chroma sample) may be signaled (e.g., as an additional mode) with a flag in the bitstream.

In examples, extended models may be used to compensate temporal and/or spatial illumination discrepancies. For example, a device may determine to use a polynomial LIC model for a block. Extended models may be filter-based and/or gradient-based linear or polynomial models. Extended models may be used to generate a prediction of a current block with illumination compensation.

Extended models may improve compression efficiency (e.g., by reducing bitrate while maintaining quality, or by improving the quality while maintaining the bitrate).

Feature(s) described herein may be used to enhance the coding efficiency of an inter block with correlated (e.g., strongly correlated) spatial illumination discrepancy information with neighboring blocks.

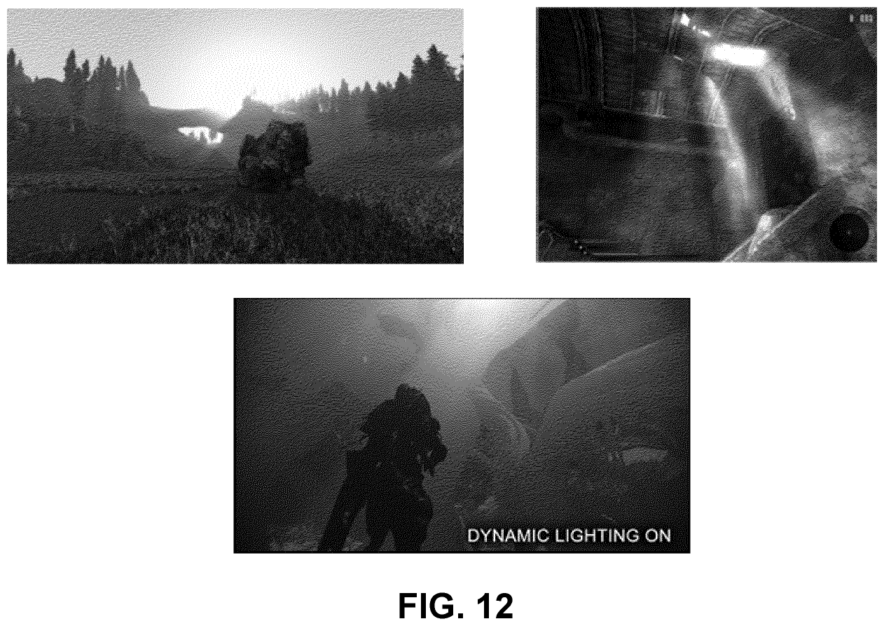

For example, an inter block may have correlated spatial illumination discrepancy information with neighboring blocks in some gaming video content (e.g., where some illumination source is located at some place in the picture and light propagates gradually across the picture). FIG. 12 illustrates examples of video game pictures where light propagates gradually across the picture. In such a case, the block to encode may include some background content with a gradually-evolving luma value according to the spatial location.

If LIC is enabled, a linear model may be applied. The linear model may explore the temporal illumination discrepancy information with reference blocks in the reference frames.

CCCM, FLM, and/or GLM may apply to the chroma intra prediction. In some examples, CCCM, FLM, and/or GLM may only apply to the chroma intra prediction, and may not be considered as techniques to enrich the illumination discrepancy information for inter prediction. CCCM, FLM, and/or GLM may be applied to enhance the coding efficiency of LIC (e.g., via generating and using multiple models). In examples described herein, extended models (e.g., models other than the simple linear model) may be used for LIC.

For example, a filter-based linear model, a filter-based polynomial model, a gradient-based linear model, and/or a gradient-based polynomial model may be applied for LIC. Feature(s) associated with signaling the extended LIC models are provided herein.

Feature(s) associated with LIC with a filtered-based model are described herein.

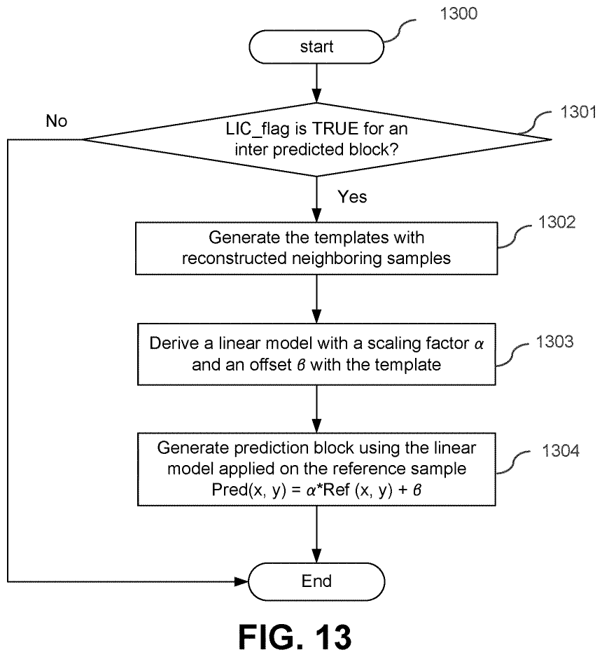

FIG. 13 illustrates an example LIC method that uses a simple linear model. When LIC is enabled for an inter-predicted block (1301), reconstructed neighboring samples of the current block and its reference block are used to generate templates (1302).

A device (e.g., a decoder or encoder) may determine to use a linear LIC model for a block. (e.g., current block). A set of LIC parameters associated with the linear LIC model may be obtained. For example, a linear model with a scaling factor α and an offset β may be derived using the LMSE method with the templates (1303). The current block may be decoded based on the set of LIC parameters associated with the linear LIC model. For example, the linear model may be applied to the reference samples to obtain prediction samples (e.g., all of the prediction samples) of the current block (1304) to compensate the temporal illumination changes.

Spatial illumination discrepancies may appear for an inter block (e.g., spatial neighboring luma gradients may be highly correlated to the luma samples in the current block). An LIC linear model (e.g., a single LIC model that uses a simple linear model) that considers temporal illumination changes may not be suitable for some blocks.

In examples, the linear model may be filter-based (e.g., FLM may be applied for LIC). The LIC with FLM may extend the simple linear regression to multiple linear regression (MLR), which can be formulated as:

$$P ( x , y ) = {\sum }_{i = 0}^{N - 1} {α}_{i} * {P}_{{r}_{i}} ( x + {v}_{x} , y + {v}_{y} ) + β$$

where P(x,y) is the prediction signal of the current block at the coordinate (x,y); Pᵣ_{ᵢ}(x+vₓ,y+v_{y}) is the i-th prediction sample surrounding the prediction sample of the reference block obtained based on the motion vector (vₓ,v_{y}); αᵢ is the i-th coefficient; β is the offset; and N is the number of involved prediction samples of the reference block.

LIC parameters may include filter coefficients (e.g., αᵢ and β) for the filter-based model. A template sample of the current block (e.g., neighboring sample in a reference region of the current block) may be identified. For a sample location (e.g., (x,y)) in the current block, a plurality of reference samples of a reference block associated with the current block (e.g., Pᵣ_{ᵢ}(x+vₓ,y+v_{y})) may be identified. Corresponding filter coefficients (e.g., αᵢ for each of the i-th prediction samples of the reference block), from the set of filter coefficients, may be applied to the plurality of neighboring samples to generate a prediction sample (e.g., P(x,y)) of the current block.

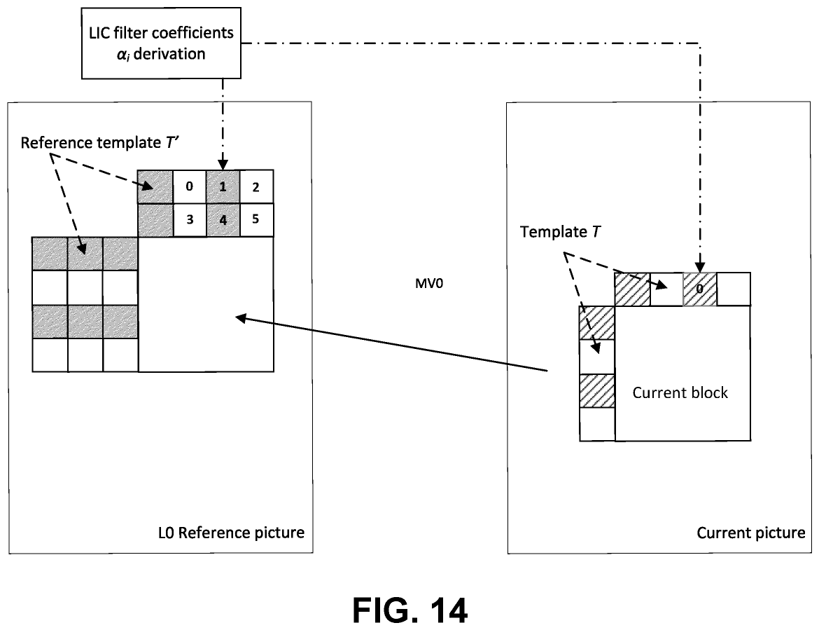

The filter coefficients αᵢ may be calculated by minimizing the difference (e.g., MSE) between a template sample of the current block (e.g., the reconstructed neighboring samples in a predefined reference region, e.g., template, of the current block) and a first reference template sample, in a template of the reference block of the current block, that corresponds to the template sample of the current block. For example, as illustrated in FIG. 14, a template sample (e.g., the reconstructed neighboring samples in the top 1 row and left 1 column of the current block, e.g., the template T in FIG. 14), and a first reference template sample that corresponds to the template sample and a plurality of reference template samples that neighbor the first reference template sample (e.g., the corresponding reconstructed neighboring samples in the top 2 rows and left 3 columns of the reference block, e.g., the template T′ in FIG. 14) may be used to derive the filter coefficients αᵢ.

For example, the set of filter coefficients may be derived based on minimizing a difference between the template sample of the block and a corresponding predicted template sample obtained based on the plurality of reference template samples. For example, MSE minimization may be performed by calculating an autocorrelation matrix for the input with reconstructed neighboring samples of the reference block and a cross-correlation vector between the input with reconstructed neighboring samples of the reference block and the output with reconstructed neighboring samples of the current block. The autocorrelation matrix may be LDL or Cholesky decomposed. The filter coefficients (e.g., the final filter coefficients) may be calculated using back-substitution.

The offset β may be set to a middle luma value (e.g., for 10-bit content, β=512). In some examples, the offset β may be set to 0. In this case, the FLM may be expressed as:

$$P ( x , y ) = {\sum }_{i = 0}^{N - 1} {α}_{i} * {P}_{{r}_{i}} ( x + {v}_{x} , y + {v}_{y} )$$

A number of filter shapes, N (e.g., N=2), may be supported. For each filter shape, the number of filter coefficients may range from a first predefined value NumFilterCoeff₁ₛₜ to a second predefined value NumFilterCoeff_{2nd}, (e.g., ranging from NumFilterCoeff₁ₛₜ=2 to NumFilterCoeff_{2nd}=6). The filter shape (and filter coefficient number) may be selected (e.g., switched) at a level (e.g., a prediction unit (PU), coding unit (CU), coding tree unit (CTU), slice, and/or frame level).

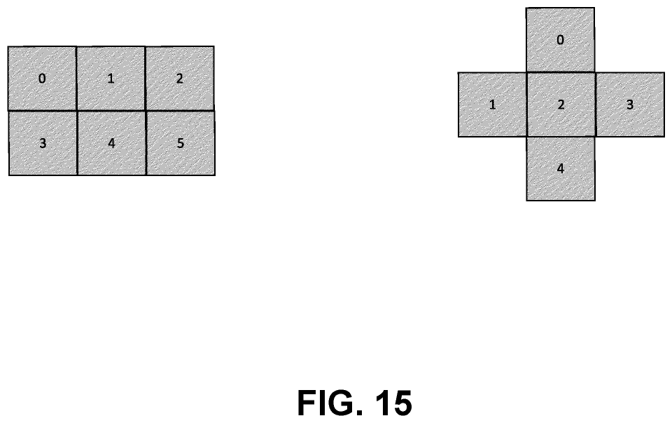

The filter shapes may be, for example, a 3×2 rectangular shape (e.g., with six filter coefficients) and a 3×3 diamond shape (e.g., with five filter coefficients), as illustrated in FIG. 15.

The polynomial LIC model may be a filter-based model (e.g., a filter-based polynomial model may be applied for LIC). For example, a convolutional 7-tap filter (e.g., which may include a 5-tap plus-sign shaped spatial component, a nonlinear term, and a bias term) may be applied for LIC. A template sample of the current block may be identified. For a sample location (e.g., (x,y)) in the current block, a plurality of reference samples (e.g., Pᵣ(x+vₓ,y+v_{y}), etc. in the equation below) of a reference block associated with the block may be identified. The plurality of reference samples may include a center reference sample (e.g., Pᵣ(x+vₓ,y+v_{y})) that corresponds to the sample location in the current block. For example, the input to the spatial 5-tap component of the filter include a first reference template sample, in a template of a reference block of the block, that corresponds to the template sample of the block (e.g., center prediction sample of the reference block obtained based on the motion vector (vₓ,v_{y}):Pᵣ(x+vₓ,y+v_{y})), and a plurality of second reference template samples that neighbor the first reference template sample (e.g., the first reference template sample's above/north (Pᵣ(x+vₓ,y+v_{y}−1)), below/south (Pᵣ(x+vₓ,y+v_{y}+1)), left/west (Pᵣ(x+vₓ−1,y+v_{y})) and right/east (Pᵣ(x+vₓ+1,y+v_{y})) neighbors), as illustrated in FIG. 9A. A corresponding predicted template sample may be obtained based on the plurality of second reference template samples. For example, an output of the filter may be calculated as a convolution between the filter coefficients cᵢ and the input values. The output of the filter may be clipped to the range of valid luma samples. Corresponding LIC parameters (e.g., filter coefficients), from the set of LIC parameters, may be applied to the plurality of reference samples to generate a prediction sample of the block. An LIC parameter corresponding to the center reference sample may be applied to the center reference sample squared (e.g., Pᵣ(x+vₓ,y+v_{y})²). For example, the LIC with filter-based polynomial model may be formulated as:

$$P ( x , y ) = {c}_{0} * {P}_{r} ( x + {v}_{x} , y + {v}_{y} ) + {c}_{1} * {P}_{r} ( x + {v}_{x} , y + {v}_{y} - 1 ) + {c}_{2} * {P}_{r} ( x + {v}_{x} , y + {v}_{y} + 1 ) + {c}_{3} * {P}_{r} ( x + {v}_{x} - 1 , y + {v}_{y} ) + {c}_{4} * {P}_{r} ( x + {v}_{x} + 1 , y + {v}_{y} ) + {c}_{5} * ( {{P}_{r} ( x + {v}_{x} , y + {v}_{y} )}^{2} + {2}^{B D - 1} ) ≫ BD + {c}_{6} * B$$

where the nonlinear term is power of two of the center prediction sample (e.g., the first reference template sample) of the reference block Pᵣ(x+vₓ,y+v_{y}) and scaled to the sample value range of the content; the linear terms correspond to the plurality of second reference template samples of the reference block; the bias term B represents a scalar offset between the input and output (similarly to the offset term in CCLM) and is set to middle luma value (B=2^{BD-1}); and BD represents the bit-depth (e.g., for 10-bit content BD=10).

A set of filter coefficients (e.g., filter coefficients cᵢ) may be derived based on minimizing a difference between the template sample of the block and the corresponding predicted template sample obtained based on the plurality of second reference template samples. For example, the filter coefficients may be calculated by minimizing the difference (e.g., MSE) between predicted and reconstructed neighboring samples in a template (e.g., a predefined template) of the current block. As illustrated in FIG. 9B, the reconstructed neighboring samples in the top six rows and left six columns of the current block (e.g., with one block width to the right and one block height below the block boundaries) may be used to derive the filter coefficients cᵢ.

The MSE minimization may be performed by calculating an autocorrelation matrix for the input with predicted neighboring samples of the current block and a cross-correlation vector between the input with predicted neighboring samples of the current block and the output with reconstructed neighboring samples of the current block. The autocorrelation matrix may be LDL or Cholesky decomposed. Filter coefficients (e.g., the final filter coefficients) may be calculated using back-substitution.

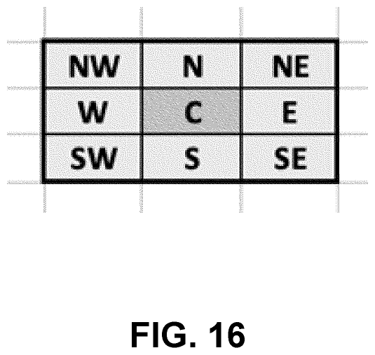

In examples, a convolutional 11-tap filter (e.g., which may include a 9-tap plus sign shape spatial component, a nonlinear term, and a bias term) may be applied for LIC. Four components (e.g., in addition to the inputs to the abovementioned spatial 5-tap component of the filter) in the 9-tap filter may include: the above-left/north-west (NW) neighbor of the center prediction sample of the reference block obtained based on the motion vector (vₓ,v_{y}): Pᵣ(x+vₓ−1,y+v_{y}−1), the above-right/north-east (NE) neighbor (Pᵣ(x+vₓ+1,y+v_{y}−1)), the below-left/south-west (SW) neighbor (Pᵣ(x+vₓ−1,y+v_{y}+1)), and the below-right/south-east (SE) neighbor (Pᵣ(x+vₓ+1,y+v_{y}+1)), as illustrated in FIG. 16. A person of ordinary skill in the art will appreciate that other possible convolutional filters (e.g., other convolutional filter structures) may be applied for LIC.

The number of filter taps, Numtap, may have a value (e.g., a predefined value) other than 9 or 11. The number of filter taps may be a fixed value or may be selected (e.g., and switched) at a level (e.g., a PU, CU, CTU, slice, and/or frame level).

The bias term B may be set to 0. In this case, the model may be expressed as:

$$P ( x , y ) = {c}_{0} * {P}_{r} ( x + {v}_{x} , y + {v}_{y} ) + {c}_{1} * {P}_{r} ( x + {v}_{x} , y + {v}_{y} - 1 ) + {c}_{2} * {P}_{r} ( x + {v}_{x} , y + {v}_{y} + 1 ) + {c}_{3} * {P}_{r} ( x + {v}_{x} - 1 , y + {v}_{y} ) + {c}_{4} * {P}_{r} ( x + {v}_{x} + 1 , y + {v}_{y} ) + {c}_{5} * ( {{P}_{r} ( x + {v}_{x} , y + {v}_{y} )}^{2} + {2}^{B D - 1} ) ≫ BD$$

Nonlinear terms (e.g., several nonlinear terms) may be used in a quadratic (e.g., second-order) polynomial model, for example:

$$P ( x , y ) = {c}_{0} * {P}_{r} ( x + {v}_{x} , y + {v}_{y} ) + {c}_{1} * {P}_{r} ( x + {v}_{x} , y + {v}_{y} - 1 ) + {c}_{2} * {P}_{r} ( x + {v}_{x} , y + {v}_{y} + 1 ) + {c}_{3} * {P}_{r} ( x + {v}_{x} - 1 , y + {v}_{y} ) + {c}_{4} * {P}_{r} ( x + {v}_{x} + 1 , y + {v}_{y} ) + {c}_{5} * ( {{P}_{r} ( x + {v}_{x} , y + {v}_{y} )}^{2} + {2}^{B D - 1} ) ≫ BD + {c}_{6} * ( {{P}_{r} ( x + {v}_{x} , y + {v}_{y} - 1 )}^{2} + {2}^{B D - 1} ) ≫ BD + {c}_{7} * ( {{P}_{r} ( x + {v}_{x} - 1 , y + {v}_{y} )}^{2} + {2}^{B D - 1} ) ≫ BD$$

Nonlinear terms (e.g., several nonlinear terms) may be used in a general polynomial model, for example:

$$P ( x , y ) = {\sum }_{i = 0}^{N - 1} {c}_{i} * {{P}_{{r}_{i}} ( x + {v}_{x} , y + {v}_{y} )}^{i} + β$$

Feature(s) associated with LIC with the gradient-based model are provided herein.

A set of LIC parameters may be derived based on a reference sample gradient (e.g., Gᵣ(x+vₓ,y+v_{y})) of a reference block associated with the current block. For example, the gradient linear model may be applied by utilizing reference sample gradients from the reference block (e.g., instead of the reference samples) to derive the linear model for LIC. For example, a gradient Gᵣ may be used in the LIC process:

$$P ( x , y ) = α * {G}_{r} ( x + {v}_{x} , y + {v}_{y} ) + β$$

where P(x,y) represents the prediction signal of the current block at the coordinate (x,y); Gᵣ(x+vₓ,y+v_{y}) represents the spatial gradient of the corresponding prediction sample of the reference block obtained based on the motion vector (vₓ,v_{y}); and the linear model parameters α and β may be derived by adjacent reconstructed samples based on the LMSE method described herein.

The offset β may be set to 0. In this case, the gradient linear model may be expressed as:

$$P ( x , y ) = α * {G}_{r} ( x + {v}_{x} , y + {v}_{y} )$$

Gᵣ(x+vₓ,y+v_{y}) may represent the spatial gradient of the corresponding reconstruction sample of the reference block obtained based on the motion vector (vₓ, v_{y}).

The linear model parameters α and β may be derived by adjacent reconstructed samples based on the minimum (Min) and maximum (Max) spatial gradient values, which simplifies the process to derive the linear model parameters. The Min and Max gradient values may be searched among the neighboring spatial gradient in the template of the reference block. After the Min and Max gradient samples are determined, the linear model parameters α and β may be obtained according to the values of the Min/Max gradients (G_{RecMax}, G_{RecMin}) and the corresponding reconstructed samples in the template of the current block (Rec_{Max}, Rec_{Min}) using the following equation:

$$α = \frac{R e {c}_{Max} - R e {c}_{Min}}{{G}_{RecMax} - {G}_{RecMin}}$$

$$β = {Rec}_{Min} - α * {G}_{RecMin}$$

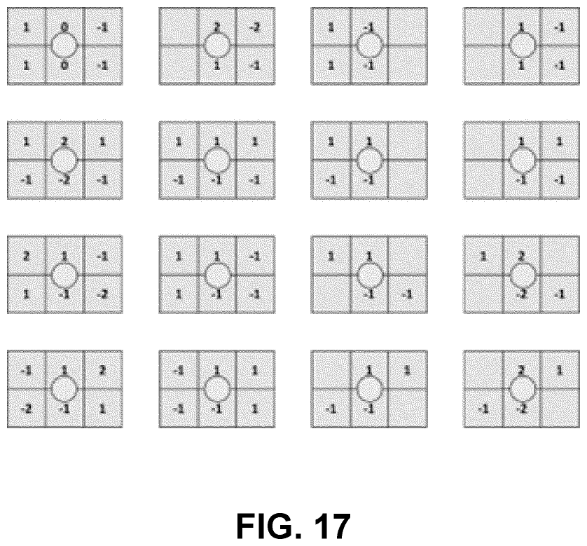

The gradient Gᵣ(x+vₓ,y+v_{y}) may be calculated based on a gradient pattern (e.g., one of four Sobel-based gradient patterns), as illustrated in FIG. 11. In some examples, the gradient pattern may be selected from more than four Sobel-based gradient patterns (e.g., such as 16 Sobel-based gradient patterns, as illustrated in FIG. 17).

Gradient patterns (e.g., other than Sobel-based gradient patterns) may be used to calculate the spatial gradient. For example, Laplacian, Prewitt, Roberts Cross, Robinson Compass, and/or Krisch Compass based gradient patterns may be used to calculate the spatial gradient.

In the case of bi-prediction, LIC may be applied for a first and second reference block associated with a current block (e.g., two reference blocks, P0ᵣ and P1ᵣ). The LIC parameters may be derived based on the first and second reference blocks. For example, the final bi-prediction P could be derived by combining P0ᵣ and P1ᵣ, and then be refined with one set of LIC parameters (a scaling factor α and an offset β) as:

$$P ( x , y ) = α * ( P {0}_{r} ( x + v {0}_{X} , y + v {0}_{y} ) + P {1}_{r} ( x + v {1}_{x} , y + v {1}_{y} ) ) + β .$$

In some examples, temporal gradients Gₜ(x,y) may be used. The LIC parameters may be derived based on one or more temporal gradients associated with the current block. For example, the temporal gradients Gₜ(x,y) may be derived as follows:

$${G}_{t} ( x , y ) = ( P {1}_{r} ( x + v {1}_{X} , y + v {1}_{y} ) - P {0}_{r} ( x + v {0}_{x} , y + v {0}_{y} ) ) / ( P o c 1 - P o c 0 )$$

where Poc0 is the picture order count of the reference picture 0, and Poc1 is the picture order count of the reference picture 1. In some examples, a term comprising Gₜ may be added to an equation, or may replace the term comprising Gᵣ in the equation. For example, a temporal gradient Gₜ can replace the combined P0ᵣ and P1ᵣ in the LIC process:

$$P ( x , y ) = α * {G}_{t} ( x + {v}_{x} , y + {v}_{y} ) + β$$

If the LIC model is a gradient-based model (e.g., a polynomial gradient-based model), a set of LIC parameters may be derived based on a reference sample in a template of the current block and a gradient of the reference sample. For example, both the reference samples and the reference sample gradients may be used to derive a linear model for LIC. In an example, the reference samples and reference sample gradients may apply different scaling factors:

$$P ( x , y ) = {α}_{0} * {P}_{r} ( x + {v}_{x} , y + {v}_{y} ) + {α}_{1} * {G}_{r} ( x + {v}_{x} , y + {v}_{y} ) + {α}_{2} * β$$

where (x,y) represents the prediction signal of the current block at the coordinate (x,y); Pᵣ(x+vₓ,y+v_{y}) represents the prediction signal of the reference block obtained based on the motion vector (vₓ,v_{y}); G(x+vₓ,y+v_{y}) represents the gradient of Pᵣ(x+vₓ,y+v_{y}). The model parameters α₀, α₁ and α₂ may be derived from six rows and columns adjacent samples based on the LDL decomposition method, as described herein. The offset β may be set to a middle luma value (e.g., for 10-bit content, β=512) or 0 (e.g., β=0).

In examples, the reference samples and reference sample gradients may share the same scaling factor α:

$$P ( x , y ) = α * ( {P}_{r} ( x + {v}_{x} , y + {v}_{y} ) + {G}_{r} ( x + {v}_{x} , y + {v}_{y} ) ) + β$$

where the linear model parameters α and β may be derived from adjacent reconstructed samples based on the LMSE method described herein.

In examples, a gradient-based polynomial model may be applied for LIC. For example, the gradient-based polynomial model may include the power of two of the reference samples and the reference sample gradients to derive the quadratic polynomial model as:

$$P ( x , y ) = {α}_{0} * ( {{P}_{r} ( x + {v}_{x} , y + {v}_{y} )}^{2} + {2}^{B D - 1} ) ≫ BD + {α}_{1} * {G}_{r} ( x + {v}_{x} , y + {v}_{y} ) + {α}_{2} * β$$

where the nonlinear term is the power of two of the prediction samples of the reference block Pᵣ(x+vₓ,y+v_{y}) and scaled to the sample value range of the content, and BD represents the bit-depth (e.g., for 10-bit content, BD=10). The set of LIC parameters (e.g., α₀ and β) may be applied to a reference sample of a reference block (e.g., Pᵣ(x+v_{X},y+v_{y})) and a gradient of the reference sample (e.g., Gᵣ(x+vₓ,y+v_{y})) to obtain a refined prediction (e.g., P(x,y)) of the current block. The current block may be reconstructed based on the refined prediction.

Feature(s) associated with signaling of the extended models are provided herein.

In examples, if LIC is enabled for an inter-predicted block, two extended LIC models: one with a filter-based model (namely LIC-FM), and one with a gradient-based model (namely LIC-GM) may be available (e.g., in addition to a simple linear model). An encoder may perform a rate distortion optimization (RDO) check (e.g., during the refine process of the inter prediction). For example, a syntax element (e.g., LIC_model) may be signaled (e.g., by truncated unary code) to indicate which model (e.g., the original LIC model, the LIC-FM model, and/or the LIC-GM model) is selected to refine the predictions of the current block. If the LIC-FM model is enabled (e.g., selected), a syntax element (e.g., filter_idx) may be signaled to indicate a chosen filter (e.g., one of a plurality of predefined filters). If the LIC-GM model is enabled, a syntax element (e.g., grad_pattern_idx) may be signaled to indicate a chosen gradient pattern (e.g., one of a plurality of predefined gradient patterns) with which to perform the gradient calculation as described herein.

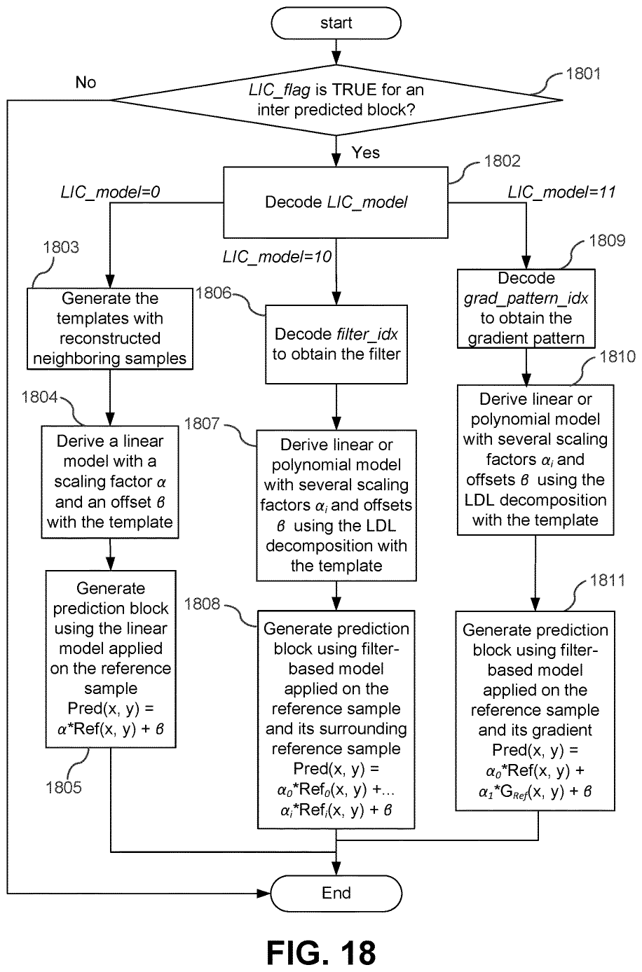

FIG. 18 illustrates an example of decoding using LIC with extended models. An LIC model indication (e.g., LIC_model) may be received (e.g., in video data). The LIC model indication (e.g., LIC flag of an inter-predicted block) may be decoded (1801). The receiving device may determine an LIC model to use (e.g., determine to use the polynomial LIC model) for the block based on the LIC model indication. For example, if LIC is enabled, a syntax LIC_model may be decoded to indicate which LIC model is applied (1802). If L/C_model is decoded as 0, the original LIC model (e.g., with the simple linear model) may be applied on the block (1803-1805).

If LIC_model is decoded as 10, the LIC-FM model with filter-based model may be applied on the block. In this case, the prediction sample of the reference block obtained based on the motion vector Pᵣ(x+vₓ,y+v_{y}), and the neighboring prediction samples surrounding the prediction sample of the reference block may also be used to generate the current prediction block. A syntax element filter_idx may be decoded to indicate a filter (e.g., a predefined filter) to apply (1806). A linear or polynomial model with a plurality of scaling factors αᵢ and an offset β may be derived using LDL decomposition with the template (1807). The derived model may be applied to the reference sample and its surrounding reference samples (1808) to obtain the prediction sample associated with the corresponding coordinator of the current block.

If LIC_model is decoded as 11, the LIC-GM model with gradient-based model may be applied on the block. In this case, the prediction sample of the reference block obtained based on the motion vector Pᵣ(x+vₓ,y+v_{y}), and the gradient of the prediction sample of the reference block Gᵣ(x+vₓ,y+v_{y}) may also be used to generate the current prediction block. A syntax element grad_pattern_idx may be decoded to indicate a gradient pattern (e.g., a predefined gradient pattern) to apply (1809). A linear or polynomial model with a plurality of scaling factors αᵢ and an offset β may be derived using LDL decomposition with the template (1810). The derived model may be applied to the reference sample and its gradient (1811) to obtain the prediction sample associated with the corresponding coordinator of the current block.

If LIC is enabled for an inter-predicted block, an extended LIC model with a filter-based model (e.g., LIC-FM) may be available (e.g., in addition to the original LIC model with a simple linear model).

If LIC is enabled for an inter-predicted block, an extended LIC model with a gradient-based model (e.g., LIC-GM) may be available (e.g., in addition to the original LIC model with a simple linear model).

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A device for video decoding, comprising:
a processor configured to:
determine to use a polynomial local illumination compensation (LIC) model for a block, wherein a degree of the polynomial LIC model is greater than one;
obtain a set of LIC parameters associated with the polynomial LIC model for the block, wherein the processor being configured to obtain the set of LIC parameters associated with the polynomial LIC model for the block comprises:
calculate an autocorrelation matrix based on reconstructed neighboring samples of a reference block;
decompose the autocorrelation matrix into a first matrix and a second matrix; and
calculate values of LIC parameters in the set of LIC parameters based on the first matrix and back-substitution; and
decode the block based on the set of LIC parameters.

2. The device of claim 1, wherein the processor is further configured to:
receive an LIC model indication in video data, wherein the processor is configured to determine to use the polynomial LIC model for the block is based on the LIC model indication.

3. The device of claim 1, wherein the polynomial LIC model is a filter-based model, and the processor is further configured to:
identify a template sample of the block;
identify a first reference template sample, in a template of a reference block of the block, that corresponds to the template sample of the block;
identify a plurality of second reference template samples that neighbor the first reference template sample; and
derive a set of filter coefficients based on minimizing a difference between the template sample of the block and a corresponding predicted template sample obtained based on the plurality of second reference template samples.

4. The device of claim 1, wherein the polynomial LIC model is a filter-based model, and the processor is further configured to:
for a sample location in the block, identify a plurality of reference samples of a reference block associated with the block, wherein the plurality of reference samples comprises a center reference sample that corresponds to the sample location; and
apply corresponding LIC parameters, from the set of LIC parameters, to the plurality of reference samples to generate a prediction sample of the block, wherein an LIC parameter corresponding to the center reference sample is applied to the center reference sample squared.

5. The device of claim 1, wherein the polynomial LIC model is a gradient-based model, and the processor being configured to calculate the autocorrelation matrix is further based on
a respective gradients of the reconstructed neighboring samples.

6. The device of claim 1, wherein the processor being configured to calculate values of LIC parameters in the set of LIC parameters is further based on
a temporal gradient associated with the reference block.

7. The device of claim 1, wherein the block is a first block, the set of LIC parameters is a first set of LIC parameters, and the processor is further configured to:
determine to use a linear LIC model for a second block;
obtain a second set of LIC parameters associated with the linear LIC model for the second block; and
decode the second block based on the second set of LIC parameters.

8. The device of claim 7, wherein the linear LIC model is a filter-based model, and the processor is further configured to:
identify a template sample of the second block;
identify a first reference template sample, in a template of a reference block of the second block, that corresponds to the template sample of the second block;
identify a plurality of second reference template samples that neighbor the first reference template sample; and
derive a set of filter coefficients based on minimizing a difference between the template sample of the second block and a corresponding predicted template sample obtained based on the plurality of second reference template samples.

9. The device of claim 7, wherein the linear LIC model is a filter-based model that comprises a set of filter coefficients, and the processor is further configured to:
for a sample location in the second block, identify a plurality of reference samples of a reference block associated with the second block; and
apply corresponding filter coefficients, from the set of filter coefficients, to the plurality of neighboring samples to generate a prediction sample of the second block.

10. The device of claim 7, wherein the linear LIC model is a gradient-based model, and the processor being configured to obtain the second set of LIC parameters comprises the processor being configured to derive the second set of LIC parameters based on a reference sample gradient of a reference block associated with the second block.

11. The device of claim 1, wherein the polynomial LIC model is a gradient-based model, and the processor is further configured to:
apply the set of LIC parameters to a reference sample of a reference block and a gradient of the reference sample to obtain a refined prediction of the block; and
reconstruct the block based on the refined prediction of the block.

12. A device for video encoding, comprising:
a processor configured to:
determine to use a polynomial local illumination compensation (LIC) model for a block, wherein a degree of the polynomial LIC model is greater than one;
obtain a set of LIC parameters associated with the polynomial LIC model for the block, wherein the processor being configured to obtain the set of LIC parameters associated with the polynomial LIC model for the block comprises:
calculate an autocorrelation matrix based on reconstructed neighboring samples of a reference block;
decompose the autocorrelation matrix into a first matrix and a second matrix; and
calculate values of LIC parameters in the set of LIC parameters based on the first matrix and back-substitution; and
encode the block based on the set of LIC parameters.

13. The device of claim 12, wherein the processor is further configured to:
send an LIC model indication in video data, wherein the LIC model indication indicates to use the polynomial LIC model for the block.

14. The device of claim 12, wherein the polynomial LIC model is a filter-based model, and the processor is further configured to:
identify a template sample of the block;
identify a first reference template sample, in a template of a reference block of the block, that corresponds to the template sample of the block;
identify a plurality of second reference template samples that neighbor the first reference template sample; and
derive a set of filter coefficients based on minimizing a difference between the template sample of the block and a corresponding predicted template sample obtained based on the plurality of second reference template samples.

15. The device of claim 12, wherein the polynomial LIC model is a filter-based model, and the processor is further configured to:
for a sample location in the block, identify a plurality of reference samples of a reference block associated with the block, wherein the plurality of reference samples comprises a center reference sample that corresponds to the sample location; and
apply corresponding LIC parameters, from the set of LIC parameters, to the plurality of reference samples to generate a prediction sample of the block, wherein an LIC parameter corresponding to the center reference sample is applied to the center reference sample squared.

16. The device of claim 12, wherein the polynomial LIC model is a gradient-based model, and the processor being configured to calculate the autocorrelation matrix is further based on
a gradient of the reference sample.

17. The device of claim 12, wherein the processor being configured to calculate the autocorrelation matrix is further based on
a temporal gradient associated with the block.

18. The device of claim 12, wherein the block is a first block, the set of LIC parameters is a first set of LIC parameters, and the processor is further configured to:
determine to use a linear LIC model for a second block;
obtain a second set of LIC parameters associated with the linear LIC model for the second block; and
encode the second block based on the second set of LIC parameters.

19. The device of claim 18, wherein the linear LIC model is a filter-based model, and the processor is further configured to:
identify a template sample of the second block;
identify a first reference template sample, in a template of a reference block of the second block, that corresponds to the template sample of the second block;
identify a plurality of second reference template samples that neighbor the first reference template sample; and
derive a set of filter coefficients based on minimizing a difference between the template sample of the second block and a corresponding predicted template sample obtained based on the plurality of second reference template samples.

20. The device of claim 18, wherein the linear LIC model is a filter-based model that comprises a set of filter coefficients, and the processor is further configured to:
for a sample location in the second block, identify a plurality of reference samples of a reference block associated with the second block; and
apply corresponding filter coefficients, from the set of filter coefficients, to the plurality of neighboring samples to generate a prediction sample of the second block.
